(19) United States
(12) Patent Application Publication
(10) Pub. No.: US 2025/0038444 A1
(43) Pub. Date: Jan. 30, 2025

(54) METAL REED STRUCTURE AND ELECTRICAL CONNECTOR

(71) Applicant: Changchun Jetty Automotive Technology Co., Ltd., Jilin (CN)

(72) Inventors: Chao WANG, Jilin (CN); Zhenfang ZUO, Jilin (CN)

(21) Appl. No.: 18/715,708

(22) PCT Filed: Dec. 2, 2022
(86) PCT No.: PCT/CN2022/136089

§ 371 Date: Jun. 1, 2024

(30) Foreign Application Priority Data
Dec. 2, 2021 (CN) 202111460439.9

(51) Int. Cl. H01R 13/187; H01R 13/24

(52) U.S. Cl. CPC H01R 13/187; H01R 13/2428; H01R 13/2492

(57) ABSTRACT

A metal reed structure and an electrical connector. The metal reed structure includes: a first side plate and a second side plate disposed opposite to each other, and a third side plate and a fourth side plate disposed opposite to each other, where the first side plate and the third side plate are located in a same plane, and the second side plate and the fourth side plate are located in a same plane; and at least one pair of first connecting reed and second connecting reed disposed opposite to each other, where two ends of the first connecting reed are connected to the first side plate and the third side plate respectively, and two ends of the second connecting reed are connected to the second side plate and the fourth side plate respectively.

### RELATED APPLICATION

This application is a National State Entry of International Application No. PCT/CN2022/136089, filed Dec. 2, 2022, and priority to Chinese Patent Application No. 202111460439.9, filed on Dec. 2, 2021, the disclosures of which are incorporated by reference as part of the present application in their entireties.

### TECHNICAL FIELD

The present application relates to the field of electrical connection technologies, in particular to a metal reed structure and an electrical connector.

### BACKGROUND

In the practical application of high-voltage connectors, the connection between a male terminal and a female terminal is a common combination in an electrical connector. Existing male terminals and female terminals are mostly formed by machining, resulting in high cost, low production efficiency and limited current-carrying capacity. At present, the plugging and unplugging directions of the male terminal are also limited, and two different female terminals are often needed to meet the usage requirements of the terminal plugged and unplugged in different directions according to the plugging and unplugging requirements of the male terminal in 90° and 180° directions. Therefore, a terminal which is convenient to machine, light in weight, low in cost and better in current-carrying capacity is now urgently needed.

### SUMMARY

An objective of the present application is to provide a metal reed structure, which not only realizes the pluggable installation of a male terminal and a female terminal in 90° and 180° directions, but also enables the male terminal and the female terminal to be directly electrically connected through the metal reed structure without the need for other adapter mechanisms, thereby facilitating assembly and saving costs.

The above objective of the present application may be achieved with the following technical solution.

In a first aspect, an embodiment of the present application provides a metal reed structure, including: a first side plate and a second side plate disposed opposite to each other, and a third side plate and a fourth side plate disposed opposite to each other, where the first side plate and the third side plate are located in a same plane, and the second side plate and the fourth side plate are located in a same plane; at least one pair of first connecting reed and second connecting reed disposed opposite to each other, where two ends of the first connecting reed are connected to the first side plate and the third side plate respectively, and two ends of the second connecting reed are connected to the second side plate and the fourth side plate respectively; and at least one pair of first cantilever reed and second cantilever reed disposed opposite to each other in a mirror image manner, where one end of the first cantilever reed is connected to the first side plate, the other end of the first cantilever reed forms a free end, one end of the second cantilever reed is connected to the second side plate, and the other end of the second cantilever reed forms a free end.

In a second aspect, an embodiment of the present application provides an electrical connector, including a female terminal of U-shaped structure, a male terminal of sheet shape, and a metal reed structure, where the female terminal is provided with a top-end opening and side openings on two sides of the female terminal, and a top hanger lug of the metal reed structure is set to be connected to the top-end opening or one of the side openings.

The present application has the following characteristics and advantages:
1. With the metal reed structure, it is not only able to realize mating installation of the female terminal and the metal reed structure in 90° and 180° directions, but also able to realize pluggable connection of the male terminal in the directions of 90° and 180°, and furthermore, the male terminal can be electrically connected to the female terminal directly through the metal reed structure without the need for other adapter mechanisms, thereby facilitating assembly and saving costs.
2. According to the design of the metal reed structure, in terms of electrical contact, the connecting reeds and the cantilever reeds are of wavy structure that can elastically deform, which ensures that the connecting reeds and the cantilever reeds are always kept in contact with the male terminal or the female terminal even if the female terminal or the male terminal moves when vibration occurs during use of the electrical connector, thereby ensuring the stability of contact resistance and the better current-carrying capacity.
3. According to the design of the metal reed structure, in terms of mechanical properties, the structure form adopts the connecting reeds and the cantilever reeds, and gaps are formed between the plurality of connecting reeds and between the plurality of cantilever reeds, which can not only disperse the force of the male terminal plugging into the metal reed structure, but also can effectively reduce the temperature rise of contact and the contact resistance.
4. The metal reed structure is provided with the top hanger lug and the side hanger lug, such that in the process of connecting the metal reed structure to the female terminal, the mating connection with the female terminal in the direction of 90° or 180° can be better implemented.
5. The metal reed structure is provided with the connecting bridge, which can play a limiting role in the insertion of the male terminal during the insertion thereof.
6. The metal reed structure is of an integrally stamped and formed structure, which effectively improves the machining efficiency and reduce the cost.

### BRIEF DESCRIPTION OF DRAWINGS

To more clearly illustrate the technical solutions in the embodiments of this application, the accompanying drawings that need to be used in the embodiments will be briefly described below. Apparently, the accompanying drawings in the description below merely illustrate some embodiments of this application. Those of ordinary skill in the art may also derive other accompanying drawings from these accompanying drawings without inventive efforts.

FIG. 1 is a schematic diagram of a metal reed structure according to the present application;

FIG. 2 is a left view of a metal reed structure according to the present application;

FIG. 3 is a front view of a metal reed structure according to the present application;

FIG. 4 is a schematic diagram in which a male terminal is plugged into a metal reed structure at 180° according to the present application;

FIG. 5 is a schematic diagram in which a male terminal is plugged into a metal reed structure at 90° according to the present application;

FIG. 6 is a schematic diagram of a metal reed structure according to another embodiment of the present application;

FIG. 7 is a left view of a metal reed structure according to another embodiment of the present application;

FIG. 8 is a schematic diagram in which a metal reed structure and a female terminal are mounted at 180° according to the present application;

FIG. 9 is a schematic diagram in which a metal reed structure and a female terminal are mounted at 90° according to the present application;

FIG. 10 is a schematic diagram in which a male terminal of an electrical connector is plugged at 180° according to the present application;

FIG. 11 is a schematic diagram in which a male terminal of an electrical connector is plugged at 90° according to the present application;

FIG. 12 is a schematic diagram of a structure of a metal reed structure according to another embodiment of the present application;

FIG. 13 is a schematic diagram of an electrical connector according to an embodiment of the present application; and

FIG. 14 is a schematic diagram of an electrical connector according to another embodiment of the present application.

### DETAILED DESCRIPTION

The technical solutions in the embodiments of the present application are clearly and completely described below with reference to the accompanying drawings in the embodiments of the present application. Apparently, the described embodiments are merely some rather than all of the embodiments of the present application. All other embodiments obtained by those of ordinary skill in the art based on the embodiments of the present application without inventive efforts shall fall within the scope of protection of the present application.

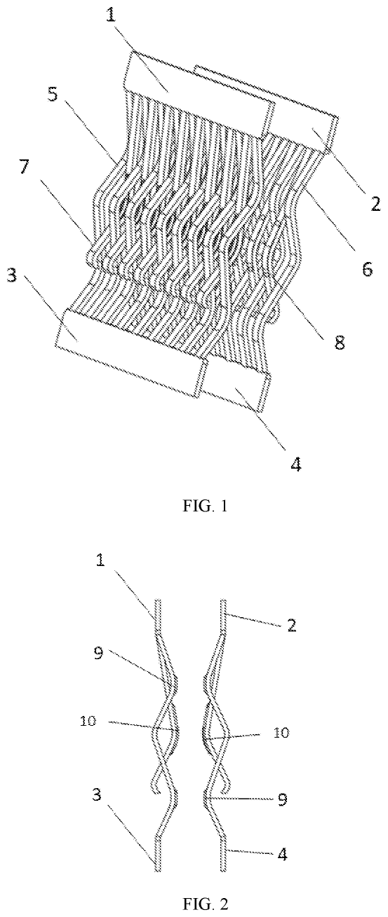

In an embodiment, as shown in FIG. 1 and FIG. 2, a metal reed structure includes: a first side plate 1 and a second side plate 2 disposed opposite to each other, and a third side plate 3 and a fourth side plate 4 disposed opposite to each other. The first side plate 1 and the third side plate 3 are located in a same plane, and the second side plate 2 and the fourth side plate 4 are located in a same plane. The metal reed structure further includes at least one pair of first connecting reed 5 and second connecting reed 6 disposed opposite to each other. Two ends of the first connecting reed 5 are connected to the first side plate 1 and the third side plate 3 respectively, and two ends of the second connecting reed 6 are connected to the second side plate 2 and the fourth side plate 4 respectively. The metal reed structure further includes at least one pair of first cantilever reed 7 and second cantilever reed 8 disposed opposite to each other. One end of the first cantilever reed 7 is connected to the first side plate 1, the other end of the first cantilever reed 7 forms a free end. One end of the second cantilever reed 8 is connected to the second side plate 2, and the other end of the second cantilever reed 8 forms a free end.

The first connecting reed 5 and the second connecting reed 6 may be disposed at a certain angle of 0-50°. When the surfaces of a female terminal 15 or a male terminal 16 are not planar surfaces parallel to each other, the first connecting reed 5 or the second connecting reed 6 may be disposed at a certain angle, such that the first connecting reed 5 and the second connecting reed 6 can be better electrically connected to the female terminal 15 or the male terminal 16, where the specific angle may be set to 5°, 10°, 20°, etc.

Similarly, an angle between the first cantilever reed 7 and the second cantilever reed 8 is 0-50°, and may specifically be 5°, 10°, 20°, etc.

Differing from a common longitudinally symmetrical structure, a structure with the same plugging direction as the male terminal 16 is used by the first cantilever reed 7 and the second cantilever reed 8 in the present application, because in practical application, if the male terminal 16 is plugged non-vertically or is plugged and unplugged for too many times, the first cantilever reed 7 and the second cantilever reed 8 are likely to be bent or broken off when not in the same direction as the male terminal 16.

As shown in FIG. 4, the first side plate 1 and the second side plate 2 of the metal reed structure are connected to one inner side surface of the female terminal 15 separately, and the third side plate 3 and the fourth side plate 4 are connected to the other inner side surface of the female terminal 15 separately. The above connection may include one or more selected from a welded connection, a screwed connection, a clamped connection, a spliced connection, and a crimped connection.

In an embodiment, protrusions may be disposed at parts of the female terminal 15 attached to the first side plate 1 and the second side plate 2, holes corresponding to the protrusions are formed at corresponding parts of the first side plate 1 and the second side plate 2, and the first side plate 1 and the second side plate 2 are in welded connection with the female terminal 15 after the holes are in limited connection with the protrusions.

In a welding method for the holes of the metal reed structure, moving ends of the third side plate 3 and the fourth side plate 4 may not be welded, so that when the male terminal 16 is plugged, the metal reed structure has an elastic extension, thereby avoiding structural yielding of the connecting reeds and the cantilever reeds due to a large plugging force for the male terminal 16.

In the above embodiment, the first side plate 1, the second side plate 2, the third side plate 3, and the fourth side plate 4 may all be welded with the female terminal 15.

Through the disposal of the metal reed structure, it can not only realize the installation of the female terminal 15 and the metal reed structure at 90° and 180°, but also realize the pluggable connection of the male terminal 16 in 90° and 180° directions, and moreover, the male terminal 16 can be electrically connected to the female terminal 15 directly through the metal reed structure without the need for other adapter mechanisms, thereby facilitating assembly and saving costs. The need for adapter mechanisms generally refers to that the female terminal 15 and the male terminal 16 generally needs to be electrically connected to each other through an adapter by means of screwing or welding.

In an embodiment, the first connecting reed 5 and the second connecting reed 6 are disposed opposite to each other in a mirror image manner. In general, the male terminal 16 is integrally machined, and the surfaces of the male terminal 16 in contact with the first connecting reed 5 and the second connecting reed 6 are generally parallel. The disposal in a mirror image manner can ensure the maximum contact surface and better electrical contact.

As above, in another embodiment, the first cantilever reed 7 and the second cantilever reed 8 are also disposed in a mirror image manner.

In an embodiment, along an extension direction of the first connecting reed 5 and the second connecting reed 6, longitudinal sections of the first connecting reed 5 and the second connecting reed 6 are wavy, and longitudinal sections of the first cantilever reed 7 and the second cantilever reed 8 are wavy. As shown in FIG. 2, an up-down direction in FIG. 2 is the extension direction of the first connecting reed 5 and the second connecting reed 6, and is also an extension direction of the first cantilever reed 7 and the second cantilever reed 8. According to the design of the metal reed structure, a wavy structure is selected, and the wavy structure has the effect of elastic deformation, such that the first connecting reed 5, the second connecting reed 6, the first cantilever reed 7, and the second cantilever reed 8 are always kept in contact with the male terminal 16 or the female terminal 15 even if the female terminal 15 or the male terminal 15 moves when vibration occurs during use of the electrical connector, thereby ensuring the stability of contact resistance and the better current-carrying capacity.

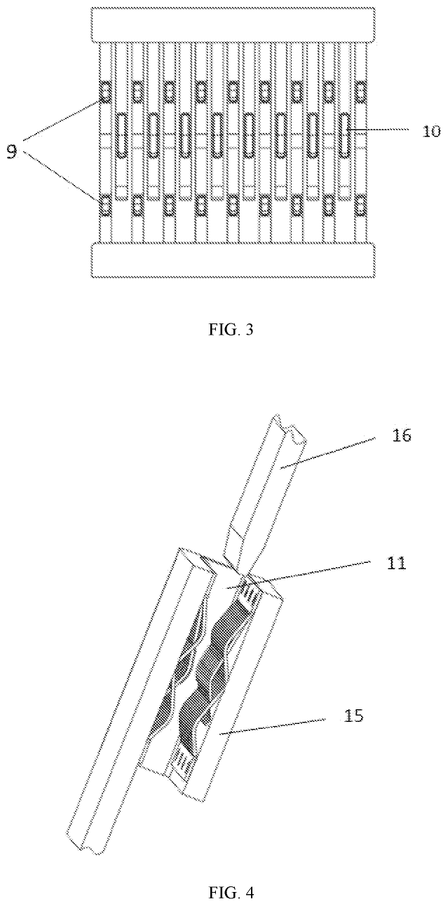

In an embodiment, as shown in FIG. 2 and FIG. 3, at least at a peak or a valley of the first connecting reed 5 and/or the second connecting reed 6, a first boss 9 raised towards an outer side of the peak or the valley is disposed; and at least at a peak or a valley of the first cantilever reed 7 and/or the second cantilever reed 8, a second boss 10 raised towards an outer side of the peak or the valley is disposed. In order to better improve the electrical conductivity, the inventor disposes first bosses 9 at peaks or valleys of the first connecting reed 5 and the second connecting reed 6, or at peaks or valleys of the first connecting reed 5 or the second connecting reed 6. Specifically, the first boss 9 may be disposed at the corresponding peak or valley according to the actual use condition. The disposal of the first boss 9 may enable the metal reed structure to be in better contact with the male terminal 16 and the female terminal 15. The first boss may be integrally formed with the first connecting reed 5 and the second connecting reed 6 by means of stamping or milling. The disposal and the achieved effect of the second boss 10 are the same as those of the first boss 9.

In an embodiment, a minimum vertical distance between a peak and a valley of the first connecting reed 5 or the second connecting reed 6 is 1-12 times a thickness of the first connecting reed 5 or the second connecting reed 6. As shown in FIG. 12, the distance H1 is the minimum vertical distance between the peak and the valley of the first connecting reed 5 or the second connecting reed 6. The larger the value of H1 is, the larger the amplitude of the wavy shape is, and the smaller the value of H1 is, the more nearly flat the wavy shape is.

In order to verify the influence of a multiple of the minimum vertical distance H1 between the peak and the valley of the first connecting reed 5 or the second connecting reed 6 to the thickness of the first connecting reed 5 or the second connecting reed 6 on the contact resistance between the first connecting reed 5 or the second connecting reed 6 and the male terminal 16 and on the overall thickness of the electrical connector, the inventor selects the same thickness of the first connecting reed 5 or the second connecting reed 6, the same linear length of the first connecting reed 5 or the second connecting reed 6, the same male terminal 16, different minimum vertical distances H1 between peaks and valleys, and corresponding female terminals 15 with different thicknesses to make a series of electrical connector samples, tests contact resistances and overall thicknesses of the electrical connector samples, and records test values in Table 1.

In a test method for the contact resistances of the electrical connector samples, a micro-resistance tester is used and is connected to the male terminal 16 and the first connecting reed 5 or the second connecting reed 6 to measure the resistance therebetween. In this embodiment, the contact resistance of less than 9 mΩ is a qualified value.

In a test method for the overall thicknesses of the electrical connector samples, a vernier caliper is used to measure the thickness of the outer side of the female terminal 15. In this embodiment, the thickness of the outer side of the female terminal 15 of less than 10 mm is a qualified value.

TABLE 1
Influence of multiple of minimum vertical distance between peak and valley of first connecting reed 5 or
second connecting reed 6 to thickness of first connecting reed 5 or second connecting reed 6 on contact resistance
of first connecting reed 5 or second connecting reed 6 and on overall thickness of electrical connector
Multiple of minimum vertical distance between peak and valley to thickness

| | | | | | | | | | | | | | | | |
|---|---|---|---|---|---|---|---|---|---|---|---|---|---|---|---|
| 0.1 | 0.5 | 1 | 2 | 3 | 4 | 5 | 6 | 7 | 8 | 9 | 10 | 11 | 12 | 13 | 14 |

Contact resistance (mΩ) between first connecting reed or second connecting reed and male terminal

| | | | | | | | | | | | | | | | |
|---|---|---|---|---|---|---|---|---|---|---|---|---|---|---|---|
| 9.7 | 9.3 | 8.7 | 8.3 | 7.9 | 7.6 | 7.2 | 6.8 | 6.5 | 6.1 | 5.7 | 5.3 | 4.9 | 4.8 | 4.6 | 4.5 |

Overall thicknesses (mm) of electrical connector samples

| | | | | | | | | | | | | | | | |
|---|---|---|---|---|---|---|---|---|---|---|---|---|---|---|---|
| 5.5 | 5.8 | 6.1 | 6.4 | 6.8 | 7.2 | 7.6 | 7.9 | 8.3 | 8.6 | 8.9 | 9.2 | 9.5 | 9.8 | 10.5 | 11.3 |

It can be seen from the above Table 1 that when the multiple of the minimum vertical distance between the peak and the valley of the first connecting reed 5 or the second connecting reed 6 to the thickness of the first connecting reed 5 or the second connecting reed 6 is less than 1, due to small deformation of the first connecting reed 5 or the second connecting reed 6, the force exerted by the first connecting reed 5 or the second connecting reed 6 on the male terminal 16 is small, and the contact area between the first connecting reed 5 or the second connecting reed 6 and the male terminal 16 is small, resulting in a contact resistance of greater than 9 mΩ between the first connecting reed 5 or the second connecting reed 6 and the male terminal 16, which is not qualified. When the multiple of the minimum vertical distance between the peak and the valley of the first connecting reed 5 or the second connecting reed 6 to the thickness of the first connecting reed 5 or the second connecting reed 6 is greater than 12, the first connecting reed 5 or the second connecting reed 6 has large deformation, such that the contact resistance is less than 9 mΩ, which meets the value requirement. However, the decreasing trend of the contact resistance slows down, and in order to obtain a long vertical distance between the peak and the valley, the thickness of the female terminal 15 can only be increased under the condition that the thickness of the male terminal 16 is unchanged, such that a gap between the female terminal 15 and the male terminal 16 is expanded, and the thickness of the female terminal 15 exceeds the required value, which is unacceptable. At this time, the electric connector cannot be plugged with a corresponding plugging sheath and cannot function. Therefore, the inventor selects the minimum vertical distance H1 between the peak and the valley of the first connecting reed 5 or the second connecting reed 6 to be 1-12 times the thickness of the first connecting reed 5 or the second connecting reed 6.

In an embodiment, a minimum vertical distance between a peak and a valley of the first cantilever reed 5 or the second cantilever reed 6 is 1-12 times a thickness of the first cantilever reed 5 or the second cantilever reed 6. As shown in FIG. 12, the distance H2 is the minimum vertical distance between the peak and the valley of the first cantilever reed 5 or the second cantilever reed 6. The larger the value of H2 is, the larger the amplitude of the wavy shape is, and the smaller the value of H2 is, the more nearly flat the wavy shape is.

In order to verify the influence of a multiple of the minimum vertical distance between the peak and the valley of the first cantilever reed 5 or the second cantilever reed 6 to the thickness of the first cantilever reed 5 or the second cantilever reed 6 on the contact resistance between the first cantilever reed 5 or the second cantilever reed 6 and the male terminal 16 and on the overall thickness of the electrical connector, the inventor selects the same thickness of the first cantilever reed 5 or the second cantilever reed 6, the same linear length of the first cantilever reed 5 or the second cantilever reed 6, the same male terminal 16, different minimum vertical distances between peaks and valleys, and corresponding female terminals 15 with different thicknesses to make a series of electrical connector samples, tests contact resistances and overall thicknesses of the electrical connector samples, and records test values in Table 2.

In a test method for the contact resistances of the electrical connector samples, a micro-resistance tester is used and is connected to the male terminal 16 and the first cantilever reed 5 or the second cantilever reed 6 to measure the resistance therebetween. In this embodiment, the contact resistance of less than 9 mΩ is a qualified value.

In a test method for the overall thicknesses of the electrical connector samples, a vernier caliper is used to measure the thickness of the outer side of the female terminal 15. In this embodiment, the thickness of the outer side of the female terminal 15 of less than 10 mm is a qualified value.

TABLE 2
Influence of multiple of minimum vertical distance between peak and valley of first cantilever reed or
second cantilever reed to thickness of first cantilever reed or second cantilever reed on contact
resistance of first cantilever reed or second cantilever reed and on
overall thickness of electrical connector
Multiple of minimum vertical distance between peak and valley to thickness

| | | | | | | | | | | | | | | | |
|---|---|---|---|---|---|---|---|---|---|---|---|---|---|---|---|
| 0.1 | 0.5 | 1 | 2 | 3 | 4 | 5 | 6 | 7 | 8 | 9 | 10 | 11 | 12 | 13 | 14 |

Contact resistance (mΩ) between first cantilever reed or second cantilever reed and male terminal

| | | | | | | | | | | | | | | | |
|---|---|---|---|---|---|---|---|---|---|---|---|---|---|---|---|
| 9.6 | 9.2 | 8.8 | 8.4 | 7.8 | 7.7 | 7.3 | 6.7 | 6.6 | 6.2 | 5.8 | 5.4 | 4.8 | 4.7 | 4.6 | 4.4 |

Overall thicknesses (mm) of electrical connector samples

| | | | | | | | | | | | | | | | |
|---|---|---|---|---|---|---|---|---|---|---|---|---|---|---|---|
| 5.6 | 5.7 | 6.1 | 6.3 | 6.7 | 7.3 | 7.5 | 7.9 | 8.4 | 8.7 | 8.9 | 9.2 | 9.5 | 9.9 | 10.4 | 11.4 |

It can be seen from the above Table 2 that when the multiple of the minimum vertical distance between the peak and the valley of the first cantilever reed 5 or the second cantilever reed 6 to the thickness of the first cantilever reed 5 or the second cantilever reed 6 is less than 1, due to small deformation of the first cantilever reed 5 or the second cantilever reed 6, the force exerted by the first cantilever reed 5 or the second cantilever reed 6 on the male terminal 16 is small, and the contact area between the first cantilever reed 5 or the second cantilever reed 6 and the male terminal 16 is small, resulting in a contact resistance of greater than 9 mΩ between the first cantilever reed 5 or the second cantilever reed 6 and the male terminal 16, which is not qualified. When the multiple of the minimum vertical distance between the peak and the valley of the first cantilever reed 5 or the second cantilever reed 6 to the thickness of the first cantilever reed 5 or the second cantilever reed 6 is greater than 12, the first cantilever reed 5 or the second cantilever reed 6 has large deformation, such that the contact resistance is less than 9 mΩ, which meets the value requirement. However, the decreasing trend of the contact resistance slows down, and in order to obtain a long vertical distance between the peak and the valley, the thickness of the female terminal 15 can only be increased under the condition that the thickness of the male terminal 16 is unchanged, such that a gap between the female terminal 15 and the male terminal 16 is expanded, and the thickness of the female terminal 15 exceeds the required value, which is unacceptable. At this time, the electric connector cannot be plugged with a corresponding plugging sheath and cannot function. Therefore, the inventor selects the minimum vertical distance between the peak and the valley of the first cantilever reed 5 or the second cantilever reed 6 to be 1-12 times the thickness of the first cantilever reed 5 or the second cantilever reed 6.

In an embodiment, a distance between adjacent peaks of the first connecting reed 5 or the second connecting reed 6 is 3-32 times a thickness of the first connecting reed 5 or the second connecting reed 6. As shown in FIG. 12, the distance L1 is the distance between the adjacent peaks of the first connecting reed 5 or the second connecting reed 6. The larger the value of L1 is, the fewer the waves in the same length are, and the smaller the value of L1 is, the denser the waves in the same length are.

In order to verify the influence of a multiple of the distance between the adjacent peaks of the first connecting reed 5 or the second connecting reed 6 to the thickness of the first connecting reed or the second connecting reed on the contact resistance between the first connecting reed 5 or the second connecting reed 6 and the male terminal 16 and on the deformation of the first connecting reed 5 or the second connecting reed 6, the inventor selects the same thickness of the first connecting reed 5 or the second connecting reed 6, the same linear length of the first connecting reed 5 or the second connecting reed 6, the same male terminal 16 and female terminal 15, and different distances between adjacent peaks to make a series of electrical connector samples, tests contact resistances of the electrical connector samples and the deformation of the first connecting reed 5 or the second connecting reed 6, and records test values in Table 3.

In a test method for the contact resistances of the electrical connector samples, a micro-resistance tester is used and is connected to the male terminal 16 and the first connecting reed 5 or the second connecting reed 6 to measure the resistance therebetween. In this embodiment, the contact resistance of less than 9 mΩ is a qualified value.

In a test method for the deformation of the first connecting reed 5 or the second connecting reed 6, a push-pull gauge is used to apply a pushing force to the peak of the first connecting reed 5 or the second connecting reed 6 to make a reaction force reach 30 N, and a distance of movement of the peak of the first connecting reed 5 or the second connecting reed 6 at this time is recorded. In this embodiment, the distance of movement of the peak of less than 0.5 mm is an unqualified value.

TABLE 3
Influence of multiple of distance between adjacent peaks of first connecting reed or second connecting
reed to thickness of first connecting reed or second connecting reed on contact resistance between first connecting
reed or second connecting reed and male terminal and on deformation of first connecting reed or second connecting reed
Multiple of minimum vertical distance between peak and valley to thickness

| | | | | | | | | | | | | | | |
|---|---|---|---|---|---|---|---|---|---|---|---|---|---|---|
| 1 | 2 | 3 | 5 | 8 | 11 | 14 | 17 | 20 | 23 | 26 | 29 | 32 | 35 | 38 |

Contact resistance (mΩ) between first connecting reed or second connecting reed and male terminal

| | | | | | | | | | | | | | | |
|---|---|---|---|---|---|---|---|---|---|---|---|---|---|---|
| 4.5 | 4.7 | 4.9 | 5.2 | 5.7 | 6.2 | 6.6 | 6.9 | 7.3 | 7.5 | 7.9 | 8.4 | 8.8 | 9.2 | 9.6 |

Distance (mm) of movement of peak

| | | | | | | | | | | | | | | |
|---|---|---|---|---|---|---|---|---|---|---|---|---|---|---|
| 0.1 | 0.3 | 0.5 | 0.6 | 0.7 | 0.9 | 1.1 | 1.3 | 1.4 | 1.5 | 1.6 | 1.8 | 1.9 | 2.1 | 2.3 |

It can be seen from the above Table 3 that when the multiple of the distance between the adjacent peaks of the first connecting reed 5 or the second connecting reed 6 to the thickness of the first connecting reed 5 or the second connecting reed 6 is less than 3, the number of peaks and valleys in the same length increases, and the contact area between the first connecting reed 5 or the second connecting reed 6 and the male terminal 16 increases, such that the contact resistance between the first connecting reed 5 or the second connecting reed 6 and the male terminal 16 is less than 9 mΩ, which meets the value requirement. However, due to the short distance between two sides of the peak or the valley, when the first connecting reed 5 or the second connecting reed 6 is under pressure, the deformation of the first connecting reed 5 or the second connecting reed 6 is small, and the distance of movement of the peak is less than 0.5 mm, which does not meet the value requirement, such that a plugging force and an unplugging force for the male terminal 16 increase, causing inconvenience to a user. When the multiple of the distance between the adjacent peaks of the first connecting reed 5 or the second connecting reed 6 to the thickness of the first connecting reed 5 or the second connecting reed 6 is greater than 32, the number of peaks and valleys in the same length decreases, and the contact area between the first connecting reed 5 or the second connecting reed 6 and the male terminal 16 decreases, such that the contact resistance between the first connecting reed 5 or the second connecting reed 6 and the male terminal 16 is greater than 9 mΩ, which does not meet the value requirement. Due to the long distance between two sides of the peak or the valley, when the first connecting reed 5 or the second connecting reed 6 is under pressure, the deformation of the first connecting reed 5 or the second connecting reed 6 is large, and the distance of movement of the peak is greater than 0.5 mm, which meets the value requirement. Therefore, the inventor selects the distance between the adjacent peaks of the first connecting reed 5 or the second connecting reed 6 to be 3-32 times the thickness of the first connecting reed 5 or the second connecting reed 6.

In an embodiment, a distance between adjacent peaks of the first cantilever reed 7 or the second cantilever reed 8 is 3-32 times a thickness of the first cantilever reed 7 or the second cantilever reed 8. As shown in FIG. 12, the distance L2 is the distance between the adjacent peaks of the first cantilever reed 7 or the second cantilever reed 8. The larger the value of L2 is, the fewer the waves in the same length are, and the smaller the value of L2 is, the denser the waves in the same length are.

In order to verify the influence of a multiple of the distance between the adjacent peaks of the first cantilever reed 7 or the second cantilever reed 8 to the thickness of the first cantilever reed 7 or the second cantilever reed 8 on the contact resistance between the first cantilever reed 7 or the second cantilever reed 8 and the male terminal 16 and on the deformation of the first cantilever reed 7 or the second cantilever reed 8, the inventor selects the same thickness of the first cantilever reed 7 or the second cantilever reed 8, the same linear length of the first cantilever reed 7 or the second cantilever reed 8, the same male terminal 16 and female terminal 15, and different distances between adjacent peaks to make a series of electrical connector samples, tests contact resistances of the electrical connector samples and the deformation of the first cantilever reed 7 or the second cantilever reed 8, and records test values in Table 4.

In a test method for the contact resistances of the electrical connector samples, a micro-resistance tester is used and is connected to the male terminal 16 and the first cantilever reed 7 or the second cantilever reed 8 to measure the resistance therebetween. In this embodiment, the contact resistance of less than 9 mΩ is a qualified value.

In a test method for the deformation of the first cantilever reed 7 or the second cantilever reed 8, a push-pull gauge is used to apply a pushing force to the peak of the first cantilever reed 7 or the second cantilever reed 8 to make a reaction force reach 30 N, and a distance of movement of the peak of the first cantilever reed 7 or the second cantilever reed 8 at this time is recorded. In this embodiment, the distance of movement of the peak of less than 0.5 mm is an unqualified value.

TABLE 4
Influence of multiple of distance between adjacent peaks of first cantilever reed or second cantilever reed
to thickness of first cantilever reed or second cantilever reed on contact resistance between first
cantilever reed or second cantilever reed and male terminal and on deformation of first cantilever reed
or second cantilever reed
Multiple of minimum vertical distance between peak and valley to thickness

| | | | | | | | | | | | | | | |
|---|---|---|---|---|---|---|---|---|---|---|---|---|---|---|
| 1 | 2 | 3 | 5 | 8 | 11 | 14 | 17 | 20 | 23 | 26 | 29 | 32 | 35 | 38 |

Contact resistance (mΩ) between first cantilever reed or second cantilever reed and male terminal

| | | | | | | | | | | | | | | |
|---|---|---|---|---|---|---|---|---|---|---|---|---|---|---|
| 4.5 | 4.7 | 4.9 | 5.2 | 5.7 | 6.2 | 6.6 | 6.9 | 7.3 | 7.5 | 7.9 | 8.4 | 8.8 | 9.2 | 9.6 |

Distance (mm) of movement of peak

| | | | | | | | | | | | | | | |
|---|---|---|---|---|---|---|---|---|---|---|---|---|---|---|
| 0.1 | 0.3 | 0.5 | 0.6 | 0.7 | 0.9 | 1.1 | 1.3 | 1.4 | 1.5 | 1.6 | 1.8 | 1.9 | 2.1 | 2.3 |

It can be seen from the above Table 4 that when the multiple of the distance between the adjacent peaks of the first cantilever reed 7 or the second cantilever reed 8 to the thickness of the first cantilever reed 7 or the second cantilever reed 8 is less than 3, the number of peaks and valleys in the same length increases, and the contact area between the first cantilever reed 7 or the second cantilever reed 8 and the male terminal 16 increases, such that the contact resistance between the first cantilever reed 7 or the second cantilever reed 8 and the male terminal 16 is less than 9 mΩ, which meets the value requirement. However, due to the short distance between two sides of the peak or the valley, when the first cantilever reed 7 or the second cantilever reed 8 is under pressure, the deformation of the first cantilever reed 7 or the second cantilever reed 8 is small, and the distance of movement of the peak is less than 0.5 mm, which does not meet the value requirement, such that a plugging force and an unplugging force for the male terminal 16 increase, causing inconvenience to a user. When the multiple of the distance between the adjacent peaks of the first cantilever reed 7 or the second cantilever reed 8 to the thickness of the first cantilever reed 7 or the second cantilever reed 8 is greater than 32, the number of peaks and valleys in the same length decreases, and the contact area between the first cantilever reed 7 or the second cantilever reed 8 and the male terminal 16 decreases, such that the contact resistance between the first cantilever reed 7 or the second cantilever reed 8 and the male terminal 16 is greater than 9 mΩ, which does not meet the value requirement. Due to the long distance between two sides of the peak or the valley, when the first cantilever reed 7 or the second cantilever reed 8 is under pressure, the deformation of the first cantilever reed 7 or the second cantilever reed 8 is large, and the distance of movement of the peak is greater than 0.5 mm, which meets the value requirement. Therefore, the inventor selects the distance between the adjacent peaks of the first cantilever reed 7 or the second cantilever reed 8 to be 3-32 times the thickness of the first cantilever reed 7 or the second cantilever reed 8.

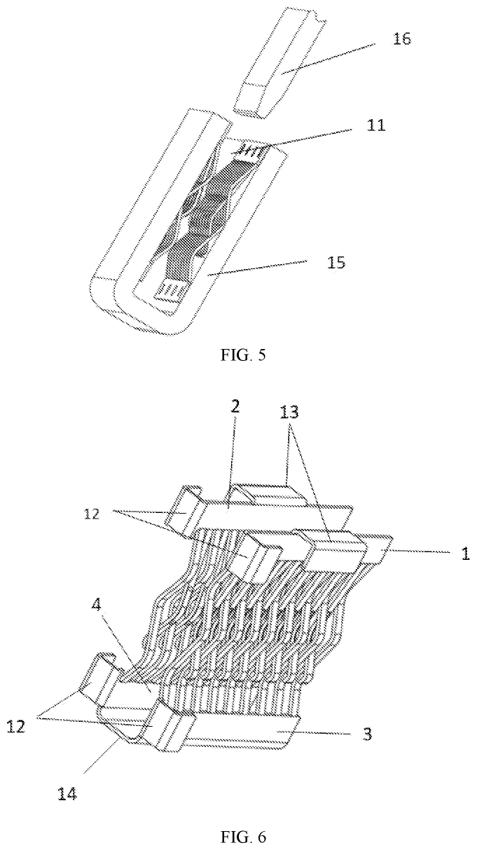

In an embodiment, as shown in FIG. 4 and FIG. 5, a terminal slot 11 is formed between the first side plate 1 and the second side plate 2, between the third side plate 3 and the fourth side plate 4, between the first connecting reed 5 and the second connecting reed 6, and between the first cantilever reed 7 and the second cantilever reed 8. The terminal slot 11 is disposed for the male terminal 16 to be plugged into and connected to.

In an embodiment, as shown in FIG. 1 and FIG. 3, the metal reed structure includes a plurality of first connecting reeds 5 and a plurality of first cantilever reeds 7. The plurality of first connecting reeds 5 and the plurality of first cantilever reeds 7 are disposed at intervals. The metal reed structure further includes a plurality of second connecting reeds 6 and a plurality of second cantilever reeds 8. The plurality of second connecting reeds 6 and the plurality of second cantilever reeds 8 are disposed at intervals.

In terms of mechanical properties, the structural form adopts a plurality of first connecting reeds 5, a plurality of first cantilever reeds 7, a plurality of second connecting reeds 6 and a plurality of second cantilever reeds 8, gaps are formed between the plurality of first connecting reeds 5 and between the plurality of first cantilever reeds 7, and the plurality of second connecting reeds 6 and the plurality of second cantilever reeds 8 are disposed at intervals, so that the force of the male terminal 16 plugging into the terminal slot 11 can be dispersed, and the temperature rise of contact between the metal reed structure and the male terminal 16 and the contact resistance therebetween can be effectively reduced.

In an embodiment, a distance between the first connecting reed 5 and the first cantilever reed 7 adjacent to each other is 1-100% of a width of the first cantilever reed 7; and a distance between the second connecting reed 6 and the second cantilever reed 8 adjacent to each other is 1-100% of a width of the second cantilever reed 8.

In order to verify the influence of the distance between the first connecting reed 5 and the first cantilever reed 7 adjacent to each other on the contact resistance of the metal reed structure, the inventor selects the metal reed structure including the first connecting reed 5 and the first cantilever reed 7 with the same shape and size as well as the male terminal 16 and the female terminal 15 with the same shape and size, and connects the metal reed structure to the female terminal 15, so as to observe the contact resistance between the male terminal 16 and the metal reed structure.

In a detection method for the contact resistance, a micro-resistance tester is used to measure the resistance at the position of contact between the male terminal 16 and the metal reed structure, and a value on the micro-resistance tester is read. In this embodiment, the contact resistance of less than 50 μΩ is an ideal value.

TABLE 5
Influence of distance between first connecting reed 5 and first cantilever reed 7 on contact resistance
between male terminal 16 and metal reed structure
Percentage (%) of distance between first connecting reed 5 and first cantilever reed 7 in
width of first cantilever reed 7

| | | | | | | | | | | | | | | | | |
|---|---|---|---|---|---|---|---|---|---|---|---|---|---|---|---|---|
| 0.3 | 0.5 | 0.8 | 1 | 10 | 20 | 30 | 40 | 50 | 60 | 70 | 80 | 90 | 100 | 103 | 105 | 110 |

Contact resistance (μΩ)

| | | | | | | | | | | | | | | | | |
|---|---|---|---|---|---|---|---|---|---|---|---|---|---|---|---|---|
| 3 | 5 | 10 | 16 | 22 | 26 | 28 | 30 | 34 | 36 | 40 | 44 | 47 | 49 | 53 | 56 | 59 |

It can be seen from Table 5 that when the percentage of the distance between the first connecting reed 5 and the first cantilever reed 7 in the width of the first cantilever reed 7 is greater than 100%, the contact resistance is greater than 50 μΩ, which does not meet the requirement. Additionally, an existing machining method for the metal reed structure is stamping or cutting machining. If the distance between the first connecting reed 5 and the first cantilever reed 7 is too short, the metal reed structure is not easy to machine. In summary, the distance between the first connecting reed 5 and the first cantilever reed 7 is defined to be 1%-100% of the width of the first cantilever reed.

As with the above method, a distance between the second connecting reed 6 and the second cantilever reed 8 is set to 1%-100% of a width of the second cantilever reed 8.

In an embodiment, the first side plate 1, the second side plate 2, the third side plate 3, and the fourth side plate 4 are connected, in an extension direction thereof, with at least one side hanger lug 12 with a U-shaped section. As shown in FIG. 6, the extension direction of the first side plate 1, the second side plate 2, the third side plate 3, and the fourth side plate 4 is a direction perpendicular to the first connecting reed 5.

In an embodiment, the first side plate 1 and the second side plate 2 are connected, in a side direction thereof, with at least one top hanger lug 13 with a U-shaped section. As shown in FIG. 6, the side of each of the first side plate 1 and the second side plate 2 is one side that is opposite to the first connecting reed 5 and the second connecting reed 6 connected to the first side plate 1 and the second side plate 2.

According to the actual use, specifically, as shown in FIG. 8 to FIG. 11, when the metal reed structure and the female terminal 15 are mounted at 90° or 180°, both the top hanger lug 13 and the side hanger lug 12 may be provided, or only the top hanger lug 13 or the side hanger lug 12 may be provided, which can be disposed according to the actual needs. The use of the side hanger lug 12 and the top hanger lug 13 may enable the metal reed structure to be more firmly connected to the female terminal 15 to achieve better electrical conductivity.

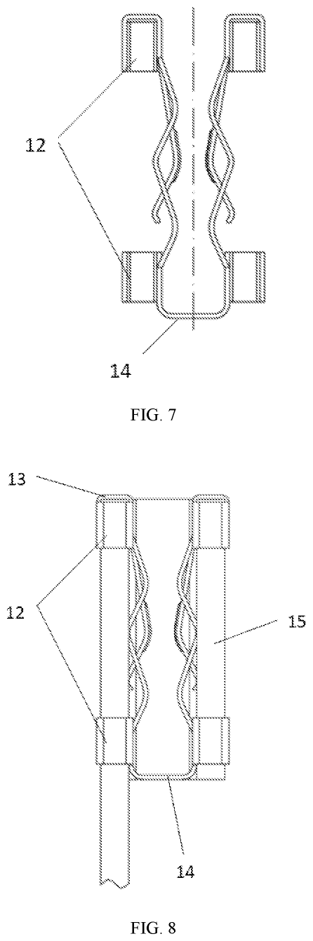

In an embodiment, as shown in FIG. 6 and FIG. 7, the third side plate 3 and the fourth side plate 4 are connected, in a side direction thereof, with at least one plate-shaped connecting bridge 14.

As shown in FIG. 8 to FIG. 11, by providing the connecting bridge 14, when the metal reed structure is mated with and connected to the female terminal 15, differing from a two-piece metal reed structure, the metal reed structure may be integrally and directly inserted into the female terminal 15 to form the terminal slot 11; and when the male terminal 16 is plugged, the connecting bridge 14 may limit the male terminal 16 to a certain extent.

In an embodiment, a material of the metal reed structure includes one or more selected from nickel, cadmium, zirconium, chromium, cobalt, manganese, aluminum, tin, titanium, zinc, copper, silver, gold, phosphorus, tellurium, beryllium, and lead.

In order to demonstrate the influence of different materials of the metal reed structure on the electrical conductivity, the inventor uses different materials to make metal reed structure samples with the same specification and size, and tests the electrical conductivities of the metal reed structure samples separately. Test results are as shown in Table 6. In this embodiment, the electrical conductivity of the metal reed structure of greater than 99% is an ideal value.

TABLE 6
Electrical conductivities of metal reed structures made of different materials
Metal reed structures made of different materials

| | | | | | | | | | | | | | | | |
|---|---|---|---|---|---|---|---|---|---|---|---|---|---|---|---|
| | | Zirco- | Chro- | | Man- | Alu- | | | | | | | | | |
| Nickel | Cadmium | nium | mium | Cobalt | ganese | minum | Tin | Titanium | Zinc | Copper | Silver | Gold | Tellurium | Beryllium | Lead |

Electrical conductivity (%) of metal reed structure

| | | | | | | | | | | | | | | | |
|---|---|---|---|---|---|---|---|---|---|---|---|---|---|---|---|
| 99.5 | 99.4 | 99.3 | 99.3 | 99.4 | 99.4 | 99.6 | 99.5 | 99.4 | 99.3 | 99.7 | 99.9 | 99.7 | 99.2 | 99.4 | 99.3 |

It can be seen from Table 6 that the electrical conductivities of the metal reed structures made of different selected metal materials are all within an ideal value range. In addition, the phosphorus is a non-metallic material and cannot be directly used as the material of the metal reed structure, but may be added into other metal to form alloy, improving the electrical conductivity and mechanical properties of the metal itself. Therefore, the inventor sets the material of the metal reed structure to include one or more selected from nickel, cadmium, zirconium, chromium, cobalt, manganese, aluminum, tin, titanium, zinc, copper, silver, gold, phosphorus, tellurium, beryllium, and lead.

In an embodiment, the material of the metal reed structure includes tellurium-copper alloy containing 0.1%-5% of tellurium, such that the metal reed structure has good electrical conductivity and easy-cutting properties, the electrical properties are ensured, and the machinability can also be improved.

In order to verify the influence of the content of tellurium in the tellurium-copper alloy in the material of the metal reed structure on the electrical conductivity of the metal reed structure, the inventor selects ten metal reed structures with the same shape for testing, where all the metal reed structures have the same size, and the materials of the metal reed structures are all tellurium-copper alloys containing 0.05%, 0.1%, 0.2%, 0.5%, 0.8%, 1.2%, 2%, 3%, 5%, 6%, and 7% of tellurium respectively. The metal reed structures are applied with a current, and the electrical conductivities of the corresponding metal reed structures are detected. Test results are as shown in Table 7. In this embodiment, the electrical conductivity of greater than 99% is an ideal value.

TABLE 7
Influence of tellurium-copper alloys containing different content of tellurium on
electrical conductivities of metal reed structures
Tellurium-copper alloys (%) containing different content of tellurium

| | | | | | | | | | | |
|---|---|---|---|---|---|---|---|---|---|---|
| 0.05 | 0.1 | 0.2 | 0.5 | 0.8 | 1.2 | 2 | 3 | 5 | 6 | 7 |

Electrical conductivities (%) of metal reed structures

| | | | | | | | | | | |
|---|---|---|---|---|---|---|---|---|---|---|
| 98.5 | 99.2 | 99.6 | 99.7 | 99.8 | 99.7 | 99.5 | 99.5 | 99.1 | 98.8 | 98.6 |

It can be seen from Table 7 that when the content of tellurium is less than 0.1% or greater than 5%, the electrical conductivity is significantly reduced, which cannot meet the ideal value requirement of the electrical conductivity. When the content of tellurium is greater than or equal to 0.2% and less than or equal to 1.2%, the electrical conductivity is the best, and when the content of tellurium is greater than 0.1% and less than 0.2%, or greater than 1.2% and less than or equal to 5%, although the electrical conductivity meets the ideal value requirement, the trend is to gradually drop, and the electrical conductivity will also degrade. Therefore, the inventor selects the tellurium-copper alloy containing 0.1%-5% of tellurium. In the most ideal case, the tellurium-copper alloy containing 0.2%-1.2% of tellurium is selected.

In an embodiment, the material of the metal reed structure includes beryllium-copper alloy containing 0.05%-5% of beryllium. Exemplarily, the content of beryllium in the material of the metal reed structure is 0.1%-3.5%.

The metal reed structure containing beryllium has high hardness, elastic limit, fatigue limit, and wear resistance, as well as good corrosion resistance, thermal conductivity, and electrical conductivity, and does not produce sparks when impacted.

In order to test the influence of the content of beryllium on the electrical conductivity of the metal reed structure, the inventor selects ten metal reed structures with the same shape and width for testing, where the metal reed structures contain 0.03%, 0.05%, 0.1%, 0.2%, 1%, 1.8%, 3%, 3.5%, 5%, and 6% of beryllium respectively. Test results are as shown in Table 8. In this embodiment, the electrical conductivity of greater than 99% is an ideal value.

TABLE 8
Influence of different content of beryllium on electrical conductivities of metal reed structures
Beryllium-copper alloys (%) containing different content of beryllium

| | | | | | | | | | |
|---|---|---|---|---|---|---|---|---|---|
| 0.03 | 0.05 | 0.1 | 0.2 | 1 | 1.8 | 3 | 3.5 | 5 | 6 |

Electrical conductivities (%) of metal reed structures

| | | | | | | | | | |
|---|---|---|---|---|---|---|---|---|---|
| 98.8 | 99.2 | 99.5 | 99.6 | 99.7 | 99.6 | 99.5 | 99.4 | 99.1 | 98.8 |

It can be seen from Table 8 that when the content of beryllium is less than 0.05% or greater than 5%, the electrical conductivity is significantly reduced, which cannot meet the actual requirement. When the content of beryllium is greater than or equal to 0.1% and less than or equal to 3.5%, the electrical conductivity is the best, such that the inventor selects the metal reed structure containing 0.05%-5% of beryllium. In the most ideal case, the metal reed structure containing 0.1%-3.5% of beryllium is selected.

In an embodiment, the material of the metal reed structure includes phosphor bronze alloy containing 0.01%-1.5% of phosphorus. Phosphor bronze has the advantages of better corrosion resistance and wear resistance, may ensure good contact and elasticity of the metal reed structure, and has excellent machinability, which may quickly shorten the machining time of parts.

In order to test the influence of the content of phosphorus on the electrical conductivity of the metal reed structure, the inventor selects ten metal reed structures with the same shape and width for testing, where the metal reed structures contain 0.001%, 0.005%, 0.01%, 0.05%, 0.1%, 0.5%, 1%, 1.5%, 2%, and 2.5% of phosphorus respectively. Test results are as shown in Table 9. In this embodiment, the electrical conductivity of greater than 99% is an ideal value.

TABLE 9
Influence of different content of phosphorus on electrical conductivities of metal reed structures
Phosphor bronze alloys (%) containing different content of phosphorus

| | | | | | | | | | |
|---|---|---|---|---|---|---|---|---|---|
| 0.001 | 0.005 | 0.01 | 0.05 | 0.1 | 0.5 | 1 | 1.5 | 2 | 2.5 |

Electrical conductivities (%) of metal reed structures

| | | | | | | | | | |
|---|---|---|---|---|---|---|---|---|---|
| 98.6 | 98.8 | 99.1 | 99.6 | 99.7 | 99.6 | 99.3 | 99.3 | 98.7 | 98.3 |

It can be seen from Table 9 that when the content of phosphorus is less than 0.01% or greater than 1.5%, the electrical conductivity is significantly reduced, which cannot meet the actual requirement. When the content of phosphorus is greater than or equal to 0.05% and less than or equal to 0.5%, the electrical conductivity is the best, such that the inventor selects the metal reed structure containing 0.01%-1.5% of phosphorus. In the most ideal case, the metal reed structure containing 0.05%-0.5% of phosphorus is selected.

In an embodiment, the material of the metal reed structure includes leaded brass alloy containing 0.1-5% of lead. The leaded brass alloy has the advantages of high strength, compact and uniform structure, good corrosion resistance, and excellent machining properties such as cutting and drilling.

In order to test the influence of the content of lead on the electrical conductivity of the metal reed structure, the inventor selects ten metal reed structures with the same shape and width for testing, where the metal reed structures contain 0.05%, 0.1%, 0.5%, 1%, 2%, 3%, 4%, 5%, 6%, and 7% of lead respectively. Test results are as shown in Table 10. In this embodiment, the electrical conductivity of greater than 99% is an ideal value.

TABLE 10
Influence of different content of lead on electrical conductivities of metal reed structures
Leaded brass alloys (%) containing different content of lead

| | | | | | | | | | |
|---|---|---|---|---|---|---|---|---|---|
| 0.05 | 0.1 | 0.5 | 1 | 2 | 3 | 4 | 5 | 6 | 7 |

Electrical conductivities (%) of metal reed structures

| | | | | | | | | | |
|---|---|---|---|---|---|---|---|---|---|
| 98.7 | 99.2 | 99.3 | 99.6 | 99.8 | 99.7 | 99.4 | 99.1 | 98.9 | 98.4 |

It can be seen from Table 10 that when the content of lead is less than 0.1% or greater than 5%, the electrical conductivity is significantly reduced, which cannot meet the actual requirement. When the content of lead is greater than or equal to 1% and less than or equal to 3%, the electrical conductivity is the best, such that the inventor selects the metal reed structure containing 0.1%-5% of lead. In the most ideal case, the metal reed structure containing 1%-3% of lead is selected.

In an embodiment, a material of the first connecting reed 5, the second connecting reed 6, the first cantilever reed 7, and the second cantilever reed 8 includes one or more selected from nickel, cadmium, zirconium, chromium, cobalt, manganese, aluminum, tin, titanium, zinc, copper, silver, gold, phosphorus, tellurium, beryllium, and lead.

In an embodiment, at least part of a surface of the metal reed structure is provided with a plating layer, to improve the corrosion resistance and the electrical conductivity and better prolong the service life.

Specifically, the first boss 9 and the second boss 10 are provided with plating layers. When the metal reed structure and the male terminal 16 are made of different materials, the plating layers can effectively reduce the contact resistance between the metal reed structure and the male terminal, reduce the voltage drop between the metal reed structure and the male terminal 16, and improve the electrical properties.

In another embodiment, plating layers are disposed at the peaks and the valleys of the first connecting reed 5 and the second connecting reed 6, and at the peaks and the valleys of the first cantilever reed 7 and the second cantilever reed 8, which reduces the voltage drops between the metal reed structure and the female terminal 15 and the male terminal 16, and improves the electrical properties.

In another embodiment, the whole metal reed structure is provided with a plating layer, such that the metal reed structure has the better electrical properties and is prolonged in service life.

In an embodiment, a material of the plating includes one or more selected from gold, silver, nickel, tin, zinc, tin-lead alloy, silver-antimony alloy, palladium, palladium-nickel alloy, graphite silver, graphene silver, hard silver, and silver-gold-zirconium alloy. In most cases, the metal reed structure is made of copper. As an active metal, the copper will react with oxygen and water during use. Therefore, one or more inactive metals are needed as plating layers to prolong the service life of the metal reed structure. The electrical conductivity and stability of the above metals are both superior to those of the copper or copper alloy, such that the metal reed structure can have the better electrical properties and the longer service life.

In order to demonstrate the influence of different materials of plating layer on the overall performance of the metal reed structure, the inventor uses metal reed structures having the same specification and material and having plating layers with different materials, each metal reed structure is wholly provided with the plating layer, and a series of corrosion resistance time tests are carried out. Test results are as shown in Table 11.

The corrosion resistance time tests in Table 11 is to place the metal reed structure samples into a salt fog spray test chamber where all parts of each sample are sprayed with salt fog, take out the samples and clean them every 20 hours to observe the surface corrosion, which is a cycle. The tests stop until the surface corrosion area is greater than 10% of the total area, and the number of cycles at that time is recorded. In this embodiment, the number of cycles of less than 80 is regarded as unqualified.

TABLE 11
Influence of different materials of plating layer on corrosion resistance of metal reed structures
Different materials of plating layer

| | | | | | | | | | | | | |
|---|---|---|---|---|---|---|---|---|---|---|---|---|
| | | | | | Silver- | | | | | | | |
| | | Silver- | | | gold- | | | | Palladium- | Tin- | | |
| | | antimony | Graphite | Graphene | zirconium | | | | nickel | lead | | Hard |
| Gold | Silver | alloy | silver | silver | alloy | Tin | Nickel | Palladium | alloy | alloy | Zinc | silver |

Number (times) of corrosion resistance test cycles

| | | | | | | | | | | | | |
|---|---|---|---|---|---|---|---|---|---|---|---|---|
| 132 | 129 | 123 | 131 | 137 | 131 | 84 | 89 | 111 | 122 | 108 | 89 | 138 |

It can be seen from Table 11 that when the material of the plating layer includes common metals such as tin, nickel, and zinc, the test results are not as good as those of other selected metals. The test results of other selected metals exceed standard values by a large margin, and the performance is relatively stable. Therefore, the inventor selects the material of the plating layer to include one or more selected from gold, silver, nickel, tin, zinc, tin-lead alloy, silver-antimony alloy, palladium, palladium-nickel alloy, graphite silver, graphene silver, hard silver, and silver-gold-zirconium alloy.

In an embodiment, the plating layer is formed by means of electroplating, chemical plating, magnetron sputtering, or vacuum plating.

The electroplating method is a process of plating a thin layer of other metals or alloys on the metal surface by using the principle of electrolysis.

The chemical plating method is a deposition process in which metals are produced by controllable oxidation-reduction reactions under the catalytic action of metals.

In the magnetron sputtering method, a magnetic field and an electric field interact with each other, such that electrons run in a spiral shape near the surface of a target, thereby increasing the probability that the electrons impact argon to generate ions. The generated ions crash into the surface of the target under the action of the electric field to sputter a target material.

In the vacuum plating method, various metal and non-metal films are deposited on the surfaces of parts by means of distillation or sputtering under vacuum.

In an embodiment, an electrical connector includes a female terminal 15 of U-shaped structure, a male terminal 16 of sheet shape, and a metal reed structure. The female terminal 15 is provided with a top-end opening and side openings on two sides of the female terminal 15. A top hanger lug 13 of the metal reed structure is set to be connected to the top-end opening or one of the side openings. The top-end opening is an opening corresponding to a direction in which the male terminal 16 is plugged, and the side opening is an opening corresponding to a direction perpendicular to the plugging direction of the male terminal 16, as shown in FIGS. 8 to 11.

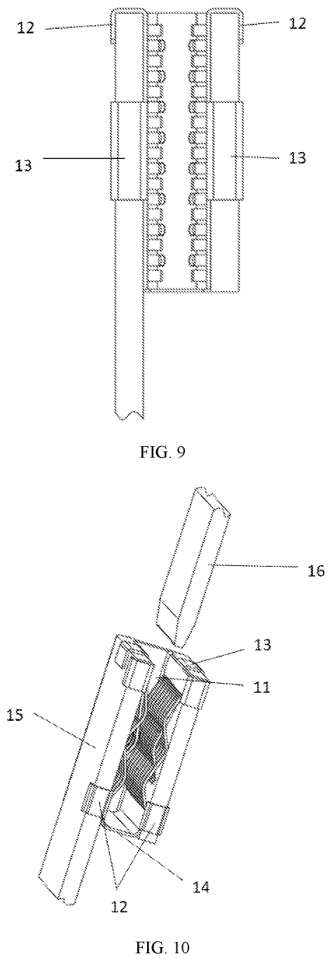

When the metal reed structure and the female terminal 15 are mounted at 90° or 180°, both the top hanger lug 13 and the side hanger lug 12 may be disposed, or only the top hanger lug 13 or the side hanger lug 12 may be disposed, which can be disposed according to the actual needs. As shown in FIG. 9, the top hanger lug 13 is connected to the side opening. As shown in FIG. 10, the top hanger lug 13 is connected to the top-end opening.

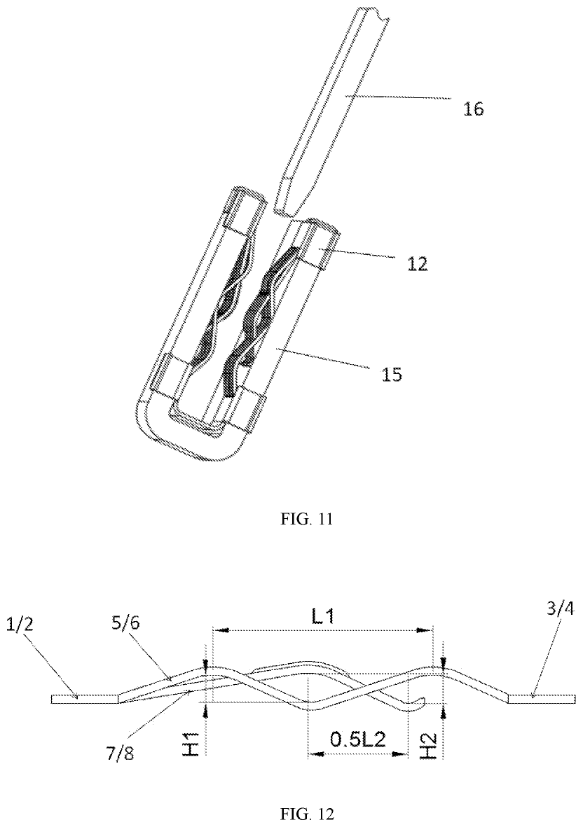

In a specific embodiment, as shown in FIG. 9 to FIG. 11, the side hanger lug 12 of the metal reed structure is set to be connected to the top-end opening, one of the side openings, or the side openings on the two sides separately. Specifically, as shown in FIG. 9, the side hanger lug 12 of the metal reed structure is connected to the top-end opening; as shown in FIG. 10, the side hanger lug 12 is connected to one of the side openings; and as shown in FIG. 11, the side hanger lug 12 is connected to the side openings on the two sides.

In a specific embodiment, as shown in FIG. 10 and FIG. 11, the first connecting reed 5, the second connecting reed 6, the first cantilever reed 7, and the second cantilever reed 8 are disposed in the female terminal 15, inner sides of the peaks of the first connecting reed 5, the second connecting reed 6, the first cantilever reed 7, and the second cantilever reed 8 are in contact with a plugging and connecting surface of the male terminal 16, and outer sides of the valleys are in contact with an inner surface of the female terminal 15. The direction towards the terminal slot 11 is the inner side, and the opposite direction is the outer side.

According to the present application, the metal reed structure, the U-shaped female terminal 15, and the male terminal 16 are designed as three separate parts, which not only facilitates assembly but also lowers the machining difficulty of a mold for the female terminal 15, may meet the requirements of plugging and unplugging in 90° and 180° directions, is applicable to the connection of the electrical connector in different directions, and reduces the cost. The metal reed structure is provided with a plurality of wavy first connecting reeds 5, a plurality of wavy second connecting reeds 6, a plurality of wavy first cantilever reeds 7, and a plurality of wavy second cantilever reeds 8, which not only can effectively ensure the stability of the contact resistance, but also can effectively disperse the force when the male terminal 16 is plugged. The metal reed structure is simple in overall structure and low in cost.

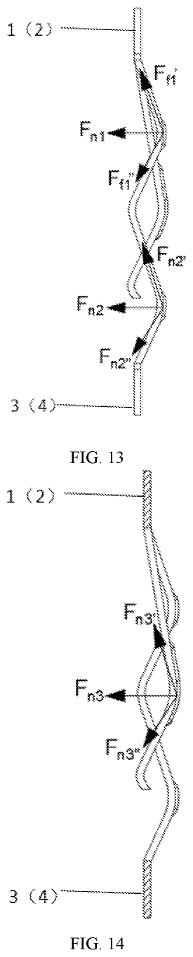

In an embodiment, as shown by Fn1 and Fn2 in FIG. 13, an elastic force applied to the male terminal 16 by the first connecting reed 5 or the second connecting reed 6 is 0.3-98 N. When the metal reed structure is mounted in the U-shaped female terminal 15 and the male terminal 16 is plugged into the metal reed structure, the first connecting reed 5 or the second connecting reed 6 will be extruded and deformed, such that the first connecting reed 5 or the second connecting reed 6 will have an elastic force applied to the male terminal 16.

In order to verify the influence of the elastic force applied to the male terminal 16 by the first connecting reed 5 or the second connecting reed 6 on the contact resistance between the first connecting reed 5 or the second connecting reed 6 and the male terminal 16 and on the plugging or unplugging force of the male terminal 16, the inventor selects the same size of the first connecting reed 5 or the second connecting reed 6, the same male terminal 16 and female terminal 15, and different elastic forces of the first connecting reed 5 or the second connecting reed 6 to make a series of electrical connector samples, tests contact resistances of the electrical connector samples and the plugging or unplugging force of the male terminal 16, and records test values in Table 12.

In a test method for the contact resistances of the electrical connector samples, a micro-resistance tester is used to be connected to the male terminal 16 and the first connecting reed 5 or the second connecting reed 6 to measure the resistance therebetween. In this embodiment, the contact resistance of less than 9 mΩ is a qualified value.

In a test method for the plugging or unplugging force of the male terminal 16, a precise push-pull gauge is used, the male terminal 16 is pushed to be plugged into or unplugged from the metal reed structure, the plugging and unplugging forces are measured, and an average value is taken. In this embodiment, the plugging or unplugging force of the male terminal 16 of greater than 25 Nis unqualified.

TABLE 12
Influence of elastic force applied to male terminal by first connecting reed or second connecting reed on
contact resistance between first connecting reed or second connecting reed and male
terminal and on plugging or unplugging force of male terminal
Elastic force (N) applied to male terminal by first connecting reed or second connecting reed

| | | | | | | | | | | | | | | |
|---|---|---|---|---|---|---|---|---|---|---|---|---|---|---|
| 0.1 | 0.2 | 0.3 | 0.5 | 1 | 15 | 30 | 45 | 55 | 70 | 80 | 90 | 98 | 105 | 110 |

Contact resistance (mΩ) between first connecting reed or second connecting reed and male terminal

| | | | | | | | | | | | | | | |
|---|---|---|---|---|---|---|---|---|---|---|---|---|---|---|
| 9.6 | 9.2 | 8.9 | 8.7 | 8.5 | 8.2 | 7.9 | 7.6 | 7.2 | 6.9 | 6.5 | 6.1 | 5.7 | 5.2 | 4.8 |

Plugging or unplugging force (N) of male terminal

| | | | | | | | | | | | | | | |
|---|---|---|---|---|---|---|---|---|---|---|---|---|---|---|
| 18.5 | 18.9 | 19.4 | 19.8 | 20.5 | 21.0 | 21.3 | 21.9 | 21.8 | 23.3 | 23.7 | 24.1 | 24.5 | 25.5 | 26.1 |

It can be seen from Table 12 that when the elastic force applied to the male terminal 16 by the first connecting reed 5 or the second connecting reed 6 is less than 0.3 N, the contact force between the first connecting reed 5 or the second connecting reed 6 and the male terminal 16 is small, and the corresponding contact area is small, such that the contact resistance between the first connecting reed 5 or the second connecting reed 6 and the male terminal 16 is greater than 9 mΩ, which does not meet the value requirement, and the larger the elastic force is, the smaller the contact resistance is. When the elastic force applied to the male terminal 16 by the first connecting reed 5 or the second connecting reed 6 is greater than 98 N, a clamping force of the first connecting reed 5 or the second connecting reed 6 on the male terminal 16 is too large, such that when the male terminal 16 is plugged into or unplugged from the metal reed structure, a large frictional force is received, the plugging or unplugging force of the male terminal 16 is greater than 25 N, which does not meet the value requirement, and the smaller the elastic force is, the smaller the plugging or unplugging force of the male terminal 16 is. Therefore, the inventor sets the elastic force applied to the male terminal by the first connecting reed 5 or the second connecting reed 6 to 0.3 N-98 N.

Further, when the elastic force applied to the male terminal 16 by the first connecting reed 5 or the second connecting reed 6 is greater than 55 N, the plugging or unplugging force of the male terminal 16 is significantly increased, so the inventor further sets the elastic force applied to the male terminal by the first connecting reed 5 or the second connecting reed 6 to 0.3 N-55 N.

In an embodiment, as shown by Fn3 in FIG. 14, an elastic force applied to the male terminal 16 by the first cantilever reed 7 or the second cantilever reed 8 is 0.3 N-98 N. When the metal reed structure is mounted in the U-shaped female terminal 15 and the male terminal 16 is plugged into the metal reed structure, the first cantilever reed 7 or the second cantilever reed 8 will be extruded and deformed, such that the first cantilever reed 7 or the second cantilever reed 8 will have an elastic force applied to the male terminal 16.

In order to verify the influence of the elastic force applied to the male terminal 16 by the first cantilever reed 7 or the second cantilever reed 8 on the contact resistance between the first cantilever reed 7 or the second cantilever reed 8 and the male terminal 16 and on the plugging or unplugging force of the male terminal 16, the inventor selects the same size of the first cantilever reed 7 or the second cantilever reed 8, the same male terminal 16 and female terminal 15, and different elastic forces of the first cantilever reed 7 or the second cantilever reed 8 to make a series of electrical connector samples, tests contact resistances of the electrical connector samples and the plugging or unplugging force of the male terminal 16, and records test values in Table 13.

In a test method for the contact resistances of the electrical connector samples, a micro-resistance tester is used to be connected to the male terminal 16 and the first cantilever reed 7 or the second cantilever reed 8 to measure the resistance therebetween. In this embodiment, the contact resistance of less than 9 mΩ is a qualified value.

In a test method for the plugging or unplugging force of the male terminal 16, a precise push-pull gauge is used, the male terminal 16 is pushed to be plugged into or unplugged from the metal reed structure, the plugging and unplugging forces are measured, and an average value is taken. In this embodiment, the plugging or unplugging force of the male terminal 16 of greater than 25 Nis unqualified.

TABLE 13
Influence of elastic force applied to male terminal by first cantilever reed or second cantilever reed on
contact resistance between first cantilever reed or second cantilever reed and male
terminal and on plugging or unplugging force of male terminal
Elastic force (N) applied to male terminal by first cantilever reed or second cantilever reed

| | | | | | | | | | | | | | | |
|---|---|---|---|---|---|---|---|---|---|---|---|---|---|---|
| 0.1 | 0.2 | 0.3 | 0.5 | 1 | 15 | 30 | 45 | 55 | 70 | 80 | 90 | 98 | 105 | 110 |

Contact resistance (mΩ) between first cantilever reed or second cantilever reed and male terminal

| | | | | | | | | | | | | | | |
|---|---|---|---|---|---|---|---|---|---|---|---|---|---|---|
| 9.4 | 9.2 | 8.9 | 8.6 | 8.5 | 8.2 | 7.9 | 7.6 | 7.2 | 6.9 | 6.5 | 6.1 | 5.7 | 5.2 | 4.8 |

Plugging or unplugging force (N) of male terminal

| | | | | | | | | | | | | | | |
|---|---|---|---|---|---|---|---|---|---|---|---|---|---|---|
| 18.5 | 18.8 | 19.3 | 19.7 | 20.1 | 20.9 | 21.2 | 21.6 | 21.8 | 23.3 | 23.7 | 24.1 | 24.5 | 25.5 | 26.1 |

It can be seen from Table 13 that when the elastic force applied to the male terminal by the first cantilever reed 7 or the second cantilever reed 8 is less than 0.3 N, the contact force between the first cantilever reed 7 or the second cantilever reed 8 and the male terminal 16 is small, and the corresponding contact area is small, such that the contact resistance between the first cantilever reed 7 or the second cantilever reed 8 and the male terminal 16 is greater than 9 mΩ, which does not meet the value requirement, and the larger the elastic force is, the smaller the contact resistance is. When the elastic force applied to the male terminal 16 by the first cantilever reed 7 or the second cantilever reed 8 is greater than 98 N, a clamping force of the first cantilever reed 7 or the second cantilever reed 8 on the male terminal 16 is too large, such that when the male terminal 16 is plugged into or unplugged from the metal reed structure, a large frictional force is received, the plugging or unplugging force of the male terminal 16 is greater than 25 N, which does not meet the value requirement, and the smaller the elastic force is, the smaller the plugging or unplugging force of the male terminal 16 is. Therefore, the inventor sets the elastic force applied to the male terminal by the first cantilever reed 7 or the second cantilever reed 8 to 0.3 N-98 N.

Further, when the elastic force applied to the male terminal 16 by the first cantilever reed 7 or the second cantilever reed 8 is greater than 55 N, the plugging or unplugging force of the male terminal 16 is significantly increased, so the inventor further sets the elastic force applied to the male terminal by the first cantilever reed 7 or the second cantilever reed 8 to 0.3 N-55 N.

In a specific embodiment, the metal reed structure is integrally formed by stamping a plate-shaped material. As shown in FIG. 1 and FIG. 6, the metal reed structure is of an integrally stamped and formed structure, which is easy to machine and low in cost.

The above are only several embodiments of the present application. Those skilled in the art may make various changes or modifications to the embodiments of the present application based on the disclosure of the application documents without departing from the spirit and scope of the present application. It is to be understood that the orientations or positional relationships indicated by the terms “length”, “width”, “upper”, “lower”, “front”, “back”, “left”, “right”, “vertical”, “horizontal”, “top”, “inside”, “outside”, etc. are based on the orientations or positional relationships shown in the accompanying drawings, only for the convenience of describing the present application and simplifying the description rather than indicating or implying that the apparatus or element referred to must have a particular orientation or be constructed and operated in a particular orientation, and therefore should not be construed as a limitation to the present application.

In addition, the terms “first”, “second”, “third”, and “fourth” are only used for descriptive purposes, and cannot be construed as indicating or implying relative importance or implying the number of technical features indicated.

In the present application, the terms such as “mounted”, “connected”, “connection”, and “fixed” should be understood in a broad sense, unless otherwise expressly specified and defined. For example, it may be a fixed connection, a detachable connection, or being integrated; it may be a mechanical connection or an electrical connection; and it may be a direct connection, an indirect connection via an intermediate medium, a communication between interiors of two elements, or an interaction between two elements. Those of ordinary skill in the art may understand specific meanings of the above terms in this application according to specific circumstances.

1. A metal reed structure, comprising:
a first side plate and a second side plate disposed opposite to each other, and a third side plate and a fourth side plate disposed opposite to each other, wherein the first side plate and the third side plate are located in a same plane, and the second side plate and the fourth side plate are located in a same plane;
at least one pair of first connecting reed and second connecting reed disposed opposite to each other, wherein two ends of the first connecting reed are connected to the first side plate and the third side plate respectively, and two ends of the second connecting reed are connected to the second side plate and the fourth side plate respectively; and
at least one pair of first cantilever reed and second cantilever reed disposed opposite to each other, wherein one end of the first cantilever reed is connected to the first side plate, the other end of the first cantilever reed forms a free end, one end of the second cantilever reed is connected to the second side plate, and the other end of the second cantilever reed forms a free end.

2. The metal reed structure according to claim 1, wherein the first connecting reed and the second connecting reed are disposed opposite to each other in a mirror image manner; or
the first cantilever reed and the second cantilever reed are disposed opposite to each other in a mirror image manner.

3. (canceled)

4. The metal reed structure according to claim 1, wherein along an extension direction of the first connecting reed and the second connecting reed, longitudinal sections of the first connecting reed and the second connecting reed are wavy, and longitudinal sections of the first cantilever reed and the second cantilever reed are wavy.

5. The metal reed structure according to claim 4, wherein at least at a peak or a valley of the first connecting reed and/or the second connecting reed, a first boss raised towards an outer side of the peak or the valley is disposed; and at least at a peak or a valley of the first cantilever reed and/or the second cantilever reed, a second boss raised towards an outer side of the peak or the valley is disposed.

6. The metal reed structure according to claim 4, wherein a minimum vertical distance between a peak and a valley of the first connecting reed or the second connecting reed is 1-12 times a thickness of the first connecting reed or the second connecting reed; or
a minimum vertical distance between a peak and a valley of the first cantilever reed or the second cantilever reed is 1-12 times a thickness of the first cantilever reed or the second cantilever reed.

7. (canceled)

8. The metal reed structure according to claim 4, wherein a distance between adjacent peaks of the first connecting reed or the second connecting reed is 3-32 times a thickness of the first connecting reed or the second connecting reed; or
a distance between adjacent peaks of the first cantilever reed or the second cantilever reed is 3-32 times a thickness of the first cantilever reed or the second cantilever reed.

9. (canceled)

10. The metal reed structure according to claim 1, wherein a terminal slot is formed between the first side plate and the second side plate, between the third side plate and the fourth side plate, between the first connecting reed and the second connecting reed, and between the first cantilever reed and the second cantilever reed.

11. The metal reed structure according to claim 1, comprising:
a plurality of first connecting reeds and a plurality of first cantilever reeds, wherein the plurality of first connecting reeds and the plurality of first cantilever reeds are disposed at intervals; and
a plurality of second connecting reeds and a plurality of second cantilever reeds, wherein the plurality of second connecting reeds and the plurality of second cantilever reeds are disposed at intervals.

12. The metal reed structure according to claim 11, wherein a distance between the first connecting reed and the first cantilever reed adjacent to each other is 1%-100% of a width of the first cantilever reed; and a distance between the second connecting reed and the second cantilever reed adjacent to each other is 1%-100% of a width of the second cantilever reed.

13. The metal reed structure according to claim 1, wherein the first side plate, the second side plate, the third side plate, and the fourth side plate are connected, in an extension direction thereof, with at least one side hanger lug with a U-shaped section.

14. The metal reed structure according to claim 1, wherein the first side plate and the second side plate are connected, in a side direction thereof, with at least one top hanger lug with a U-shaped section.

15. The metal reed structure according to claim 1, wherein the third side plate and the fourth side plate are connected, in a side direction thereof, with at least one plate-shaped connecting bridge.

16. The metal reed structure according to claim 1, wherein a material of the metal reed structure comprises one or more selected from nickel, cadmium, zirconium, chromium, cobalt, manganese, aluminum, tin, titanium, zinc, copper, silver, gold, phosphorus, tellurium, beryllium, and lead.

17. The metal reed structure according to claim 1, wherein at least part of a surface of the metal reed is provided with a plating layer.

18. The metal reed structure according to claim 17, wherein a material of the plating layer comprises one or more selected from gold, silver, nickel, tin, zinc, tin-lead alloy, silver-antimony alloy, palladium, palladium-nickel alloy, graphite silver, graphene silver, hard silver, and silver-gold-zirconium alloy.

19. An electrical connector, comprising a female terminal of U-shaped structure, a male terminal of sheet shape, and the metal reed structure according to claim 1, wherein the female terminal is provided with a top-end opening and provided with side openings on two sides of the female terminal, and a top hanger lug of the metal reed is set to be connected to the top-end opening or one of the side openings.

20. The electrical connector according to claim 19, wherein a side hanger lug of the metal reed is set to be connected to the top-end opening, one of the side openings, or the side openings on the two sides separately.

21. The electrical connector according to claim 19, wherein the first connecting reed, the second connecting reed, the first cantilever reed, and the second cantilever reed are disposed in the female terminal, inner sides of the peaks of the first connecting reed, the second connecting reed, the first cantilever reed, and the second cantilever reed are in contact with a plugging and connecting surface of the male terminal, and outer sides of the valleys are in contact with an inner surface of the female terminal.

22. The electrical connector according to claim 21, wherein an elastic force applied to the male terminal by the first connecting reed or the second connecting reed is 0.3 N-98 N; or
an elastic force applied to the male terminal by the first cantilever reed or the second cantilever reed is 0.3 N-98 N.

23-25. (canceled)

26. The electrical connector according to claim 19, wherein the metal reed is integrally formed by stamping a plate-shaped material.
